(19) United States
(12) Patent Application Publication
(10) Pub. No.: US 2015/0281816 A1
(43) Pub. Date: Oct. 1, 2015

(54) Music Photo Album

(71) Applicant: Danielle Boggess, Pittsboro, NC (US)

(72) Inventor: Danielle Boggess, Pittsboro, NC (US)

(21) Appl. No.: 14/679,261

(22) Filed: Apr. 6, 2015

Related U.S. Application Data
(60) Provisional application No. 61/971,737, filed on Mar. 28, 2014.

(51) Int. Cl. H04R 1/02; H04R 3/00

(52) U.S. Cl. CPC H04R 1/028; H04R 3/00

(57) ABSTRACT

The present invention provides a photo album having a system for incorporating music with photos and a method of using the same. The music playing system for playing digital music files includes a reed switch, a microcontroller, and a speaker assembly having a digital-to-analog converter, an amplifier, and a speaker. The reed switch is configured to detect opening and closing of the photo album, wherein opening of the photo album prompts the reed switch transmits an output digital signal to the microcontroller. The microcontroller is coupled with a digital data port that is configured to receive a digital storage medium having user-selected digital music files to drive a speaker assembly. Upon receipt of the output digital signal from the reed switch, the microcontroller is configured to retrieve the digital music files and transmit the digital music files to the speaker assembly to drive the speaker.

### CROSS REFERENCE TO RELATED APPLICATION

This application claims the benefit of U.S. Provisional Application No. 61/975,294 filed on Apr. 4, 2014. The above identified patent application is herein incorporated by reference in its entirety to provide continuity of disclosure.

### BACKGROUND OF THE INVENTION

1. Field of the Invention

The present invention relates to multimedia devices. More specifically, the present invention pertains to an improved printed photo album with a music playing system for playing user selected music while viewing the same.

Photo albums are a way to cherish and preserve memories. Whether it is a wedding album, a travel photo album or any other types of albums, photo albums are a great way to keep your favorite memories close. For example, weddings are a very nostalgic event and are often cherished for decades. Photos are often taken to document these priceless moments on camera to cherish these memories for years.

There are also many images and stories that are meant to be remembered when a person travels. A photo album is a great way to capture these albums in an organized fashion through photographs. In addition, a traveler and fellow travelers can collaborate to create a photo album full of sentiment and nostalgia. Besides being a great way to remember a special trip, it is also a great tool to use for sharing one's globetrotting experience with others.

Furthermore, songs may also bring about nostalgia for different moments and experiences. Some songs are sentimental tunes that take a person back to a key moment in a relationship. It could be a song that played for the first dance as a married couple, or a song that played on a first date. Other songs may remind one of specific fun experiences on a trip with companions. These songs as well as photos are particularly important as they have sentimental value. However, with printed photo albums, there is not a convenient way to review a photo album with music playing in the background that enhances the nostalgia.

The present invention provides a photo album with a system for incorporating music with photos. The album includes a front cover panel, a back cover panel, and a spine panel extending between the front cover panel and the back cover panel from edge to edge. The album further includes a music playing system for playing user-selected digital music files including a reed switch, microcontroller, and a speaker assembly having a digital-to-analog converter, an amplifier, and a speaker. The reed switch detects opening and closing of the photo album and transmits a signal to the microcontroller indicating the satisfaction of the condition. The microcontroller is electrically coupled with a digital data port that is adapted to receive a digital storage medium. The microcontroller is configured to retrieve digital music files stored on the digital storage medium and transmit the digital music files to the speaker assembly to play the digital music files.

2. Description of the Prior Art

Devices have been disclosed in the prior art that relate to multimedia albums. These include devices that have been patented and published in patent application publications. Some of these devices provide a system to a tablet that records videos and takes photographs in electronic communication with a USB port. Other devices provide a photo album in electronic communication with multiple media devices. These devices, however, do not provide a photo album with a system for playing music utilizing a reed switch and a digital data port. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 8,503,857 to Sikorski provides a system to record videos and take photographs, which can be placed into a photo album. The Sikorski device further provides an electronic recording and video displaying tablet as removably mounted on the cover of the album. The tablet is also in electric communication with a USB port to download new photographs or charge the device. However, the Sikorski device does not provide a system for playing digital music files in a photo album.

Similarly, U.S. Pat. No. 6,975,832 to Adams device provides a photo album having electrical conductors which connect to data storage devices storing audio and image data. The Adams device further provides a speaker for audio sound bites retrieved from the storage devices. The image data can also be retrieved from the storage devices. The Adams device further discloses a wireless link that is capable of downloading data via a wireless connection. However, the Adams device does not provide a reed switch within the music playing system that is configured to detect opening and closing of a photo album.

Published U.S. Patent Application Number 2007/0124673 to Trotto provides an interactive multimedia diary system. The Trotto system uses an interface connected to a plurality of different media content devices, whereby a user can collect and arrange images, videos, and other content to input a diary entry. However, the Trotto device does not provide a system with a reed switch configured to detect the opening of a photo album, thereby activating a speaker assembly.

U.S. Pat. No. 8,448,360 to Guo provides an interactive greeting card activated by a flap sensor. The Guo device provides an audio module and a series of flaps across the greeting card. The audio module is activated by the opening of the card, and when the series of flaps inside the card are opened. However, the Guo device does not provide a music playing system having a digital data port configured to receive a digital storage medium configured to store user-selected digital music files to be played while viewing a photo album.

Finally, published U.S. Patent Application Number 2011/0288929 to Hua provides methods for recommending music and advertising while a user browses photos. The Hua method ranks songs and ads with a text-based algorithm based on at least one photo within an album, wherein the method then maps the music, advertisements, and photos to a style and mood ontology to obtain vector-based representations for the music, advertisements and photos. The music and advertisements are then re-ranked by a weighted relevancy term to the photo. The Hua method provides recommended music and advertisements as the user browses photos. However, the Hua method does not relate to photo albums having music playing systems

The devices disclosed in the prior art have several known drawbacks. These devices are limited to devices that include systems to record videos and take photographs or photo albums that have multimedia storage devices The present invention overcomes these limitations by providing a photo album having a music playing system, wherein a reed switch detects opening of the photo album and triggers a microcontroller to retrieve and transmit user-selected digital music files from a digital storage medium to a speaker assembly. It is therefore submitted that the present invention is substantially divergent in design elements from the prior art, and consequently it is clear that there is a need in the art for an improvement to photo albums. In this regard, the instant invention substantially fulfills these needs.

### SUMMARY OF THE INVENTION

In view of the foregoing disadvantages inherent in the known types of multimedia devices now present in the prior art, the present invention provides a new and improved photo album having a system for playing music triggered by a reed switch with a digital data port to select and download music to a user's preference.

It is therefore an object of the invention to provide a new and improved music photo album that has all of the advantages of the prior art and none of the disadvantages.

Another object of the present invention is to provide a new and improved music photo album having a music playing system configured to play user-selected digital music files while a photo album is opened.

Another object of the present invention is to provide a new and improved music photo album having a music playing system having a reed switch configured to detect opening and closing of the photo album and transmit an output digital signal to a microcontroller upon detecting the opening of the photo album.

Still yet another object of the present invention is to provide a new and improved music photo album wherein the microcontroller is coupled with a digital data port that is configured to receive a digital storage medium having user-selected digital music files to drive a speaker assembly.

Yet another object of the present invention is to provide a new and improved music photo album wherein said microcontroller is configured to retrieve the digital music files and transmit the digital music files to drive the speaker assembly having a digital-to-analog converter, an amplifier and a speaker, while the photo album is open.

Still yet another object of the present invention is to provide a new and improved music photo album wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a schematic diagram of the system in the present invention.

FIG. 2 shows a side view of the present invention.

FIG. 3 shows another side perspective of the present invention.

### DETAILED DESCRIPTION OF THE INVENTION

References are made herein to the attached drawings. Like reference numerals are used throughout the drawings to depict like or similar elements of the music photo album. For the purposes of presenting a brief and clear description of the present invention, the preferred embodiment will be discussed as used for playing selected music while reviewing photos in an album. The figures are intended for representative purposes only and should not be considered to be limiting in any respect.

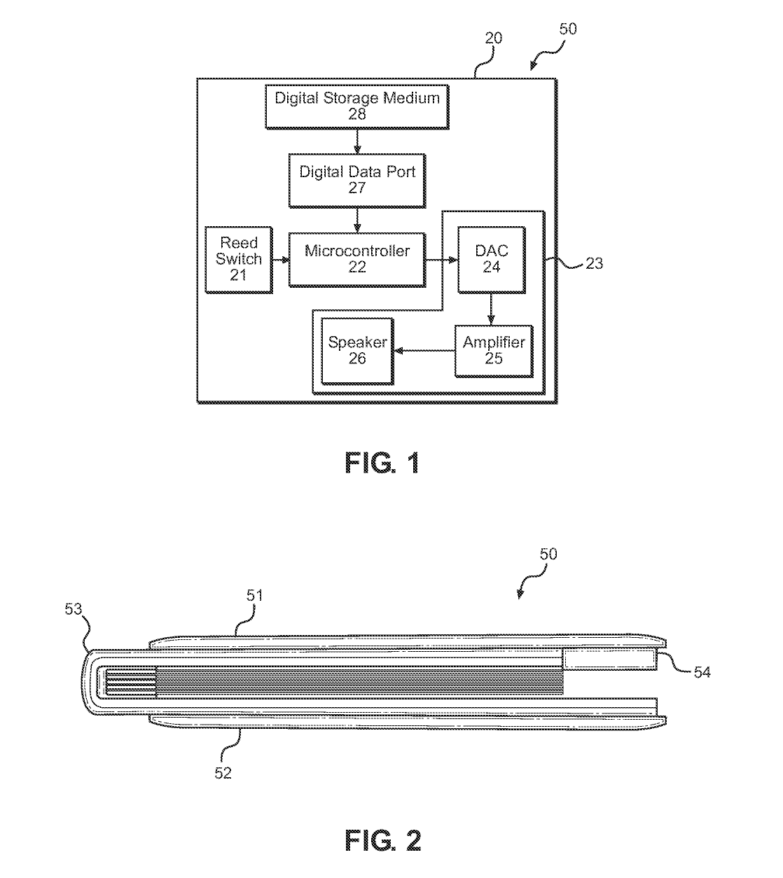

Referring now to FIG. 1, there is shown a schematic diagram of the music playing system 20 of a photo album 50. The photo album 50 comprises a music playing system 20 for incorporating and playing digital music files, while reviewing photos within the album 50. The music playing system 20 includes a reed switch 21, a microcontroller 22, and a speaker assembly 23. The reed switch 21 is configured to detect opening and closing of the album 50, wherein the reed switch 21 transmits an output digital signal to the microcontroller 22 when the album 50 is opened and stops the transmission when album 50 is closed.

The microcontroller 22 is electrically coupled with a digital data port 27 that is configured to receive a digital storage medium 28 configured to store user-selected digital music files. Upon receipt of the output digital signal from the reed switch 21, the microcontroller 22 is configured to retrieve the digital music files stored within the digital storage medium 28 and transmit the digital music files to the speaker assembly 23.

The speaker assembly 23 comprises a digital-to-analog converter (DAC) 24, an amplifier 25, and a speaker 26. The digital music files transmitted from the microcontroller 22 is converted into an analog signal by the DAC 24. The analog signal is then amplified by the amplifier 25 and the digital music files, now in an analog signal, are played through the speaker 26. The reed switch 21 also detects closing of the album 50, wherein the reed switch 21 stops the transmission of the output digital signal, thereby deactivating the speaker assembly 23.

In the preferred embodiment, the system 20 uses a reed switch 21 to detect the opening and closing of the album 50, however, the reed switch 21 is alternative composed of other means, including magnetic sensors like hall effect sensors. The reed switch 21 is an electrical switch operated by an applied magnetic field. It comprises a pair of contacts on ferrous metal reeds in an airtight glass envelope. The contacts are normally open making no electrical contact. The reed switch 21 is actuated closed by bringing a magnet near the reed switch 21. Once the magnet is pulled away, the reed switch 21 returns to its original position. The reed switch 21 is configured to transmit a digital output signal when the album 50 is opened, and does not provide an output signal when the album 50 is closed.

The digital output signal is transmitted to the microcontroller 22. The microcontroller 22 does not have to be sophisticated as it functions primarily as a pathway between the reed switch 21 and DAC 24 of the speaker assembly 23, however the microcontroller 22 is also configured to retrieve digital music files stored on the digital storage medium 28. The digital music files are transmitted to the DAC 24, which primarily functions to convert the digital music files retrieved by the microcontroller 22 to an analog signal to drive the speaker 26. The amplifier 25 intensifies generally low powered analog signals from the DAC 24 to a level suitable for driving speaker 26. Generally, an input signal to the amplifier 25 may only be a few hundred microwatts, however, the amplifier 25 can output tens to hundreds of watts based on preference. The speaker 26 receives the output analog signal from the amplifier 25 and plays the music originally stored as the digital music files in the digital storage medium 28.

The system 20 utilizes a digital data port 27 in electric communication with the microcontroller 22. The digital data port 27 is preferably a universal serial bus (USB) port. The USB as referred to within the scope of this document is an industry standard that defines the cables, connectors, and protocols used for connection, communication and power supply between computers and electronic devices; thereby enabling uploading and downloading of digital data, such as pictures, text, sound or the like. The digital data port 27 is also preferably used for charging the system 20, wherein a digital storage medium 28, preferably a USB, can be electrically connected to a computer or an outlet as a power source.

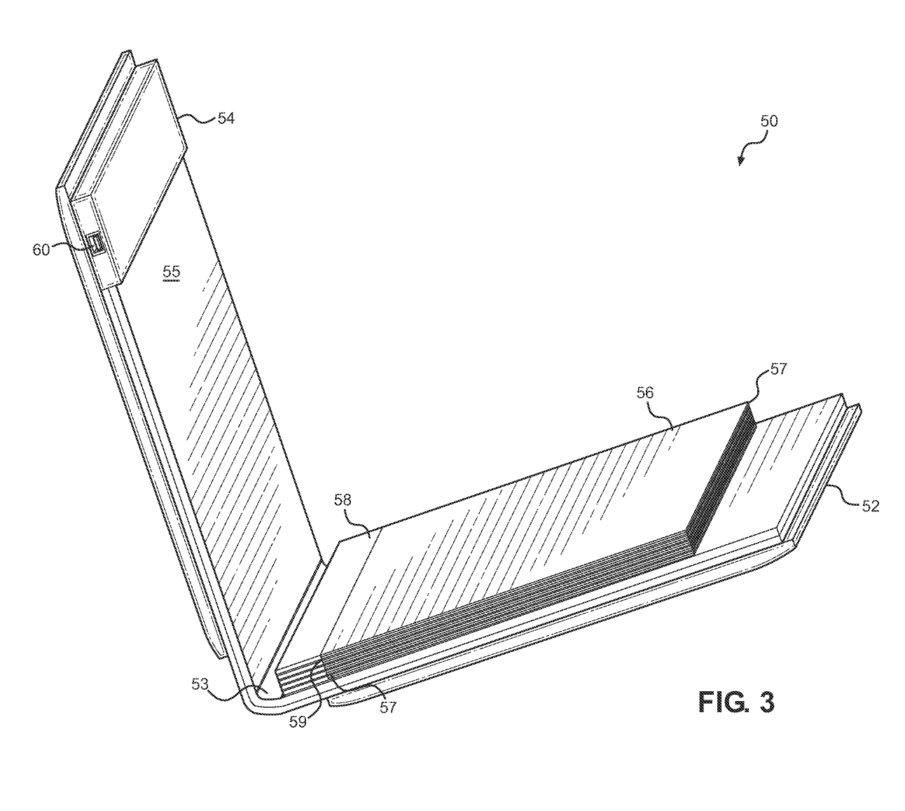

Referring now to FIGS. 2 and 3, there are shown a pair of side perspectives the album 50 as it is open and closed. The album 50 comprises a front cover panel 51, a back cover panel 52, and a spine panel 53 extending between the front cover panel 51 and back cover panel 52 from edge to edge. The cover panel 51 further includes a housing 54 that is mounted on the interior surface 55 of the front cover panel 51. The housing 54 comprises one or more sides and a rear surface enclosing an interior chamber that stores the music playing system and any electrical communication wiring means may also be confined therein. The housing 54 further comprises an opening 60 that is configured to allow the digital storage medium to be received by the digital data port.

The album 50 further comprises an album retainer 58 comprising at least one album page 56 having an inner edge 57, wherein the inner edges 57 of the album pages 56 are bound with each other such that the album retainer 55 is configured to be turned from the first album page 56 to the last album page 56. The album pages 56 are positioned to be overlapping with and between the front cover panel 51 and back cover panel 52. The album retainer 58 further comprises at least one edge leave 59 connecting the inner edges 57 of the album pages 56, wherein each of the edge leaves 59 couples between sequent album pages 56 to allow the album pages 56 to be stacked on one another in a co-planar manner. The album pages 56 can also be turned, wherein the album pages 56 would overlap with the front cover panel 51 and back cover panel 52.

The album retainer 58 can be secured to the album 50 by any suitable securing means. Purely as an example, album retainer 58 may further comprise a retention sheet overlapping the outer side of the last album page 56 that is mounted on an interior surface of the back cover panel 52.

According to the preferred embodiment, the photo album 50 further provides a method of playing music pre-selected by a user, comprising the steps of:

selecting digital music files to save onto a digital data medium configured to be electronically connected with a digital data port;
receiving said digital data medium within said digital data port;
activating said music playing system using a reed switch that detects opening and closing of a photo album triggering a transmission of an output digital signal to a microcontroller;
retrieving said digital music files from said digital storage medium using said microcontroller upon receipt of said transmission from said reed switch;
transmitting said digital music files to a speaker assembly having a digital-to-analog converter, an amplifier, and a speaker;
converting said digital music files to an analog signal using said digital-to-analog converter;
amplifying said analog signal configured to drive said speaker using said amplifier;
playing said analog signal through said speaker while said photo album is open.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A music photo album, comprising:
a photo album having a front cover panel, a back cover panel, and a spine panel;
said back cover panel comprising an album retainer having at least one album page with an inner edge, and at least one edge leave that binds said album pages together;
a securing means for securing said album retainer to said back cover panel;
said front cover panel comprising a housing enclosing a music playing system for playing user-selected digital music files upon opening and closing of said photo album;
said music playing system comprising a reed switch, a microcontroller, a digital data port, and a speaker assembly;
said speaker assembly having a digital-to-analog converter, an amplifier, and a speaker;
wherein said microcontroller is electrically coupled with said digital data port;
wherein said digital data port configured to receive a digital storage medium having digital music files selected by said user to drive said speaker assembly;
said digital data port also providing a means to charge said music playing system.

2) The music photo album of claim 1, wherein said reed switch of said music playing system detects opening and closing of said photo album, which triggers transmission of an output digital signal and stops said transmission when said photo album is closed.

3) The music photo album of claim 2, wherein said microcontroller of said music playing system upon receipt of a digital signal from said reed switch, retrieves said digital music files from said digital storage medium and transmits said digital music files to said speaker assembly;
wherein said speaker plays said digital music files stored on said digital storage medium as long as said photo album is open.

4) The music photo album of claim 1, wherein said housing is attached to an interior surface of said front cover panel.

5) The music photo album of claim 4, wherein said housing comprises:
at least one side and a rear surface enclosing an interior chamber;
wherein said rear surface is mounted on the interior surface of said front cover panel.

6) The music photo album of claim 5, wherein said digital data port is accessible through said side of said housing.

7) A method of playing music while simultaneously viewing a photo album, comprising the steps of:
selecting digital music files to save onto a digital data medium configured to be electronically connected with a digital data port;
receiving said digital data medium within said digital data port;
activating said music playing system using a reed switch that detects opening and closing of a photo album triggering a transmission of an output digital signal to a microcontroller;
retrieving said digital music files from said digital storage medium using said microcontroller upon receipt of said transmission from said reed switch;
transmitting said digital music files to a speaker assembly having a digital-to-analog converter, an amplifier, and a speaker;
converting said digital music files to an analog signal using said digital-to-analog converter;
amplifying said analog signal configured to drive said speaker using said amplifier;
playing said analog signal through said speaker while said photo album is open.
